(19) United States
(12) Patent Application Publication
(10) Pub. No.: US 2024/0247965 A1
(43) Pub. Date: Jul. 25, 2024

(54) RADAR CIRCUIT FOR A LEVEL MEASURING DEVICE

(71) Applicant: VEGA Grieshaber KG, Wolfach (DE)

(72) Inventors: Christoph MUELLER, Oppenau (DE); Roland WELLE, Hausach (DE); Daniel SCHULTHEISS, Hornberg (DE)

(73) Assignee: VEGA Grieshaber KG, Wolfach (DE)

(21) Appl. No.: 18/420,393

(22) Filed: Jan. 23, 2024

(30) Foreign Application Priority Data
Jan. 23, 2023 (DE) 10 2023 101 550.8

(51) Int. Cl. G01F 23/284

(52) U.S. Cl. CPC G01F 23/284

(57) ABSTRACT

A radar circuit for a level measuring device is provided, including: a first application-specific integrated circuit (ASIC); and a second ASIC, the first ASIC having a first structure size and/or being manufactured by a first semiconductor technology, the second ASIC having a second structure size and/or being manufactured by a second semiconductor technology, the first structure size being different from the second structure size, and/or the first semiconductor technology being different from the second semiconductor technology.

### CROSS-REFERENCE TO RELATED APPLICATIONS

This application claims the benefit of priority under 35 U.S.C. § 119 from German Patent Application No. 10 2023 101 550.8 filed on 23 Jan. 2023, the entire content of which is incorporated herein by reference.

### TECHNICAL FIELD

The present invention relates to measuring device technology for process automation in industrial or private environments. In particular, the invention relates to a radar circuit for a level measuring device, a use of such a radar circuit and a radar level measuring device with a radar circuit.

### BACKGROUND

In process measurement technology in industrial or private environments, measuring devices with radar processors are used, which can be used for level measurement or object monitoring. Such measuring devices emit a radar measurement signal, which is reflected by a product surface, for example, and beamed back to the measuring device. The level can be determined from the reflected radar measurement signal received. Such radar processors can also be designed for measuring devices, which are known as reflection microwave barriers. These detect whether an object is in the beam path or not.

The power supply of the measuring devices used is often significantly limited, as they are connected to a 4 mA to 20 mA two-wire line, for example, or are self-sufficient and operate without an external power supply.

In particular, there is a tension between the accuracy of the measurement and its frequency on the one hand and the energy requirement and service life of the measuring device on the other.

### SUMMARY

There may be a desire to provide an energy-efficient radar processor for a measuring device, with which a high measuring accuracy can be provided with low energy consumption.

A first aspect of the present disclosure relates to a radar circuit for a level measuring device comprising a first and a second application specific integrated circuit (ASIC).

The first ASIC has a first structure size and/or is manufactured in a first semiconductor technology. The second ASIC, on the other hand, has a second structure size and/or is manufactured using a second semiconductor technology. The first structure size is different from the second structure size and/or the first semiconductor technology is different from the second semiconductor technology.

In this way, it may be possible to adapt the processing and operation of the two ASICs to the requirements that they have to fulfill. For example, the first (or second) ASIC can be used for control and measurement value calculation tasks, while the second (or first) ASIC is set up to generate the radar measurement signal. These two tasks take place at very different operating frequencies. For example, the second ASIC can be designed to have an operating range of 6 GHz, 24 GHz, 60 GHz, 80 GHz, 120 GHz, 180 GHz, or 240 GHz, or higher.

In particular, it may be possible for the first ASIC and the second ASIC to divide the components required for processing the measurement task between them. In particular, the first ASIC can have a phase locked loop (PLL), while the second

ASIC is responsible for generating the radar measurement signal.

In particular, the second ASIC may be a Monolithic Microwave Integrated Circuit (MMIC).

The first ASIC, on the other hand, may have an operating range in the megahertz range, for example at 40 MHz.

In particular, the structure size of the first (or the second) ASIC may be smaller than 50 nm, whereas the structure size of the second (or the first) ASIC may be significantly larger, for example 130 nm.

According to an embodiment of the present disclosure, the first ASIC and the second ASIC are stacked on top of each other or overlapping each other.

For example, the first ASIC is arranged on a carrier plate, whereas the second ASIC is arranged on the first ASIC.

The second ASIC may be arranged on or in a recess in the carrier plate, whereby the first ASIC is arranged on the second ASIC.

According to an embodiment, the first ASIC has a metallization on its upper side as a reflector in order to reflect the radar measurement signals generated by the second ASIC and thus direct them in a different direction, towards the product.

According to a further embodiment, the carrier plate below the first ASIC has a metallization as a reflector in order to reflect the radar measurement signals generated by the second ASIC.

According to a further embodiment, the radar circuit has a primary radiator which is set up to emit the radar measurement signal generated by the second ASIC, the primary radiator being arranged on the second ASIC or on the carrier plate.

According to a further embodiment, the first ASIC has a PLL, an analog-to-digital converter (ADC) circuit, a finite state machine (FSM), and/or a digital interface to a processor of the radar circuit.

According to a further embodiment, the first ASIC is set up to supply a voltage-controlled oscillator (VCO) of the second ASIC and/or a multiplier of the second ASIC.

According to a further embodiment, the first ASIC and the second ASIC are separate components. The second ASIC is a radar chip that is set up to generate a radar measurement signal, which is then emitted by an antenna or a radiating element. The processor mentioned above is set up to determine a measured value from the radar signals received. The two ASICs are interconnected via corresponding control and supply lines.

The first ASIC may be designed as a radar companion ASIC, which performs control tasks and/or measured value acquisition tasks in the radar circuit. In this way, essential control and acquisition tasks can be combined in a compact unit at low cost when using different radar chips, while at the same time enabling energy-efficient operation of the corresponding radar chip.

The term “process automation in an industrial environment” maybe understood as a branch of technology that includes measures for the operation of machines and systems without the involvement of humans. One aim of process automation is to automate the interaction of individual components of a plant in the chemical, food, pharmaceutical, petroleum, paper, cement, shipping, or mining industries. A variety of sensors can be used for this purpose, which are adapted in particular to the specific requirements of the process industry, such as mechanical stability, insensitivity to contamination, extreme temperatures, and extreme pressures. Measured values from these sensors are usually transmitted to a control room, where process parameters such as fill level, limit level, flow rate, pressure, or density can be monitored and settings for the entire plant can be changed manually or automatically.

An area of process automation in the industrial environment concerns the logistics automation of systems and the logistics automation of supply chains. Distance and angle sensors are used in logistics automation to automate processes inside or outside a building or within an individual logistics system. Typical applications for logistics automation systems include baggage and freight handling at airports, traffic monitoring (toll systems), retail, parcel distribution and building security (access control). What the examples listed above have in common is that presence detection in combination with precise measurement of the size and position of an object is required by the respective application. Sensors based on optical measurement methods using lasers, LEDs, 2D cameras, or 3D cameras, which detect distances according to the time-of-flight (ToF) principle, can be used for this purpose.

Another area of process automation in the industrial environment is factory/production automation. Applications for this can be found in a wide variety of sectors such as automotive manufacturing, food production, the pharmaceutical industry or in the packaging sector in general. The aim of factory automation is to automate the production of goods using machines, production lines and/or robots, i.e., to run them without human intervention. The sensors used here and the specific requirements in terms of measuring accuracy when detecting the position and size of an object are comparable to those in the previous example of logistics automation.

According to a further aspect, a radar level measuring device with a radar circuit described above and below is provided.

A further aspect of the present disclosure relates to the use of a radar circuit described above in a radar level meter.

### BRIEF DESCRIPTION OF THE FIGURES

In the following, embodiments of the present disclosure are described with reference to the figures. If the same reference signs are used in the following description of the figures, these designate the same or similar elements. The illustrations in the figures are schematic and not to scale.

FIG. 1 shows a circuit diagram of a radar MMIC with a peripheral circuit using discrete components.

FIG. 2 shows a radar companion ASIC that can perform control and detection tasks when operating a purely analog MMIC.

FIG. 3 shows the structure of a radar circuit for a radar measuring device with the ASIC of FIG. 2.

FIG. 4 illustrates the universal usability of the Radar Companion (RC) ASIC for widely used radar MMICs for level measurement.

FIG. 5 shows a lateral assembly and connection technique.

FIG. 6 shows an arrangement with a primary radiator on top of the stacked ASICs.

FIG. 7 shows an arrangement with a primary radiator between the ASICs.

FIG. 8 shows an arrangement with a primary radiator between the ASICs.

FIG. 9 shows an arrangement with a primary radiator next to the stacked ASICs.

FIG. 10 shows an arrangement with a primary radiator on an intermediate level of the stacked ASICs.

FIG. 11 shows an arrangement with an MMIC in a cavity of the carrier circuit board.

FIG. 12 shows an arrangement with an MMIC and an RC ASIC in a deep cavity of a multilayer carrier board.

FIG. 13 shows a measuring device in the form of a radar level gauge.

### DETAILED DESCRIPTION OF EMBODIMENTS

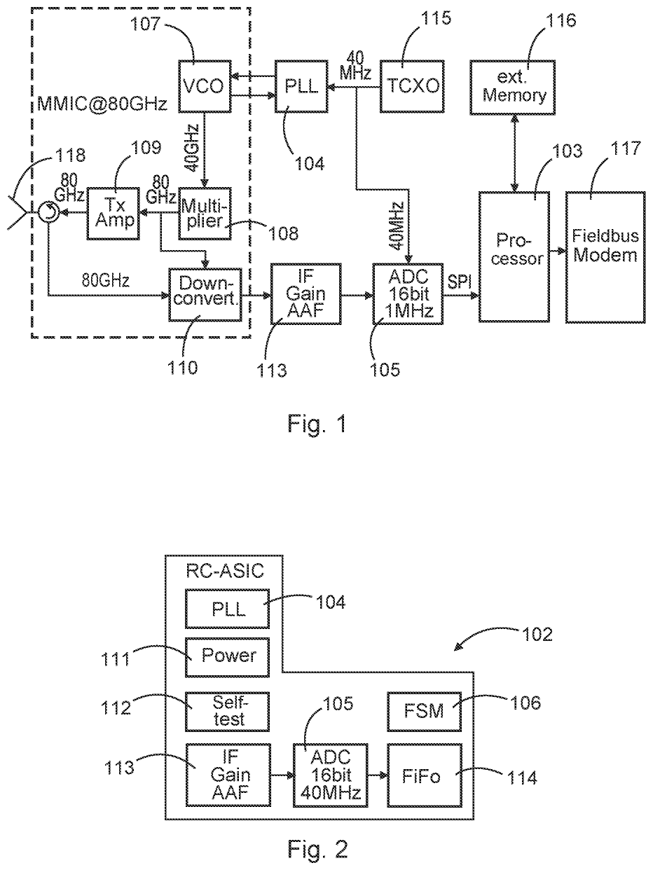

FIG. 1 shows a radar MMIC with a peripheral circuit using discrete components. The radar MMIC generates a radar measurement signal of 80 GHz, which is emitted via the antenna 118 in the direction of the product. The MMIC has a voltage-controlled oscillator (VCO) 107, which is controlled by an external PLL 104. A temperature compensated crystal oscillator (TCXO) oscillator 115 is provided, which controls the PLL with a frequency of 40 MHz. The TCXO also controls the analog-to-digital converter (ADC) circuit 105.

In addition to the VCO 107, the MMIC has a multiplier 108, which is controlled by the VCO 107 at 40 GHz. The multiplier doubles the frequency and controls the transmitter (TX) amplifier 109, which is connected to the antenna 118 via a transmit/receive switch, for example a circulator. In addition, a down converter 110 is provided, which receives signals from the multiplier 108 and the transmit/receive switch.

All other components are located outside the MMIC. The down converter 110 sends its signal to an amplification and filter circuit 113, which then passes it on to the ADC 105. The ADC 105 is connected to the processor 103 via an serial peripheral interface (SPI). The processor 103 can exchange data with an external memory 116. In addition, the processor 103 is connected to a fieldbus modem 117 for measured value transmission.

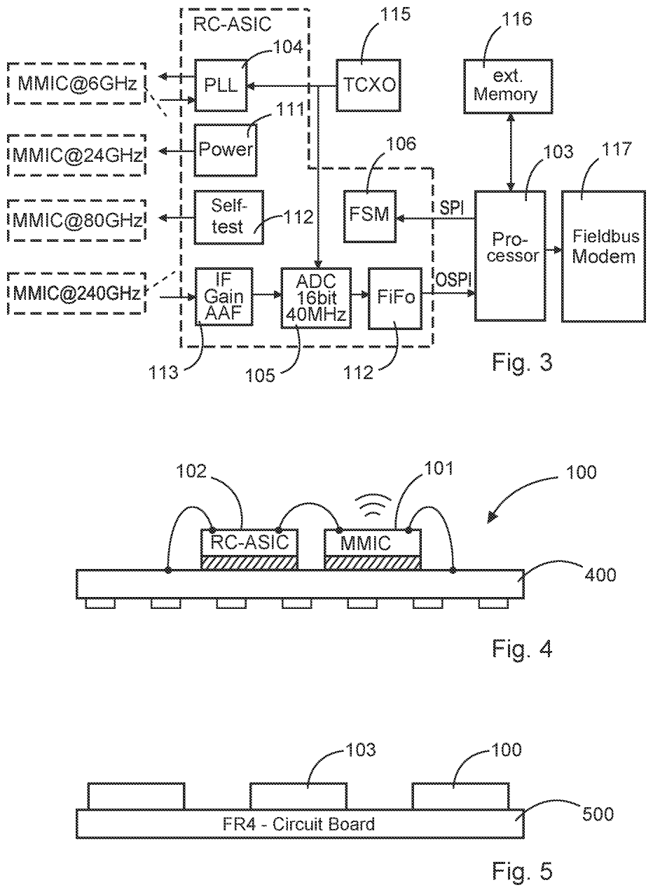

FIG. 2 shows a radar companion ASIC 102, which can take over control and detection tasks during operation of a purely analog MMIC. The ASIC 102 has a linearization circuit, for example an integer or fractional rational PLL 104, a power supply 111, a self-test circuit 112, an amplification and filter circuit 113 or IF gain AAF circuit 113, an ADC circuit 104 (which is set up, for example, to convert analog signals into digital values with an accuracy of 16 bits and a sampling frequency of 40 MHz), a first-in-first-out (FiFo) memory 114, and a finite state machine 106. The ASIC 102 is a separate component, but can be arranged on the same circuit board as the MMIC 101 (see FIG. 3). FIG. 3 shows the structure of a radar circuit 100 for a radar measuring device, which has the ASIC 102 described above. The ASIC 102 is connected between the radar chip (MMIC 101) and the processor 103. Communication between ASIC 102 and processor 103 takes place, for example, via the FiFo 114 using a quad serial peripheral interface (QSPI) and, starting from the processor 103, via an SPI interface to the FSM 106.

The ASIC 102 can supply the VCO 107 and the multiplier 108 of the MMIC 101 with energy and perform or trigger a self-test of the MMIC 101 (see FIG. 3). In particular, the RC ASIC 102 can be used to check the function of the MMIC 101. This is particularly advantageous for safety integrity level (SIL) applications. It is possible that the processor 103 is integrated on the ASIC 102. However, it can also be a separate component, as shown in FIG. 3.

In particular, the MMIC 101 and the RC ASIC 102 can be manufactured using different semiconductor technologies and chip materials. For example, the MMIC can be optimized for use at high frequencies, for example 80 GHz or above, whereas the RC-ASIC 102 is optimized for applications at significantly lower frequencies, for example 40 MHz. This can save energy compared to integrating the ASIC module on an MMIC.

FIG. 3 shows the universal usability of the RC-ASIC 102 for radar MMICs for level measurement, which are designed for very different frequency ranges, for example for 6 GHz, 24 GHz, 80 GHz, 180 GHz, and 240 GHz.

FIG. 4 shows a lateral assembly and connection technique for providing a radar circuit 100. The radar circuit 100 has a carrier plate 400 on which a first ASIC in the form of an RC ASIC 102 is arranged. A further ASIC in the form of an MMIC 101 is arranged next to it. The electrical connection between the two ASICs 101, 102 and the carrier plate 400 can be made by means of bonding wires.

The carrier plate 400 can be realized in the form of a printed circuit board. It may also be intended to use a glass material, a ceramic material, or a semiconductor material as the carrier plate 400.

The ASICs 101, 102 usually have a back-end layer 401, 402, which can be made of a semiconductor material, for example. Above the back-end layer 401, 402, there are usually one or more structured layers 403, 404, which contain the function of the circuits. A connection to other chips or a carrier plate 400 can preferably—but not exclusively—be established starting from a functional layer 403, 404.

FIG. 5 shows the module 100 shown in the upper illustration of FIG. 4 on a printed circuit board substrate 500, for example an FR4 printed circuit board. The processor 103 is arranged next to it, as well as an example of another electronic component, for example a resistor.

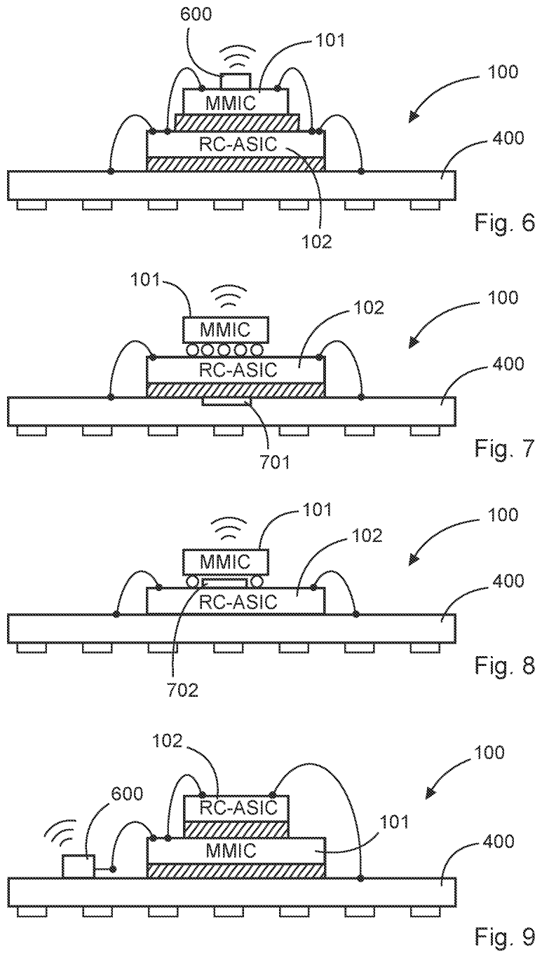

FIG. 6 shows an arrangement or radar circuit 100 with a primary radiator 600, which is located on the top of the MMIC 101. The RC ASIC 102 is located between the MMIC 101 and the carrier plate 400. Here too, the electrical connection between the individual components can be made using bonding technology.

FIG. 7 shows a further arrangement 100 with a primary radiator 600 (not shown), which is located on the underside of the second ASIC 101, i.e., between the two ASICs 101, 102.

A metallization 701 is located on the carrier 400 or in the carrier plate 400, which serves as a reflector for the radar measurement signal emitted by the primary radiator 600 located on the underside of the MMIC 101.

FIG. 8 shows an arrangement 100 with the primary radiator between the two ASICs 101, 102. On the upper side of the lower, first ASIC 102 there is a metallization 702 as a reflector, at a distance λ/2 from the primary radiator.

FIG. 9 shows an arrangement 100 with the primary radiator 600 arranged on the surface of the carrier plate 400 next to the second ASIC 101. The primary radiator 600 can be connected to the second ASIC 101 using bonding technology. The second ASIC (MMIC) 101 is located on the top of the carrier plate and the first ASIC 102 is located above it.

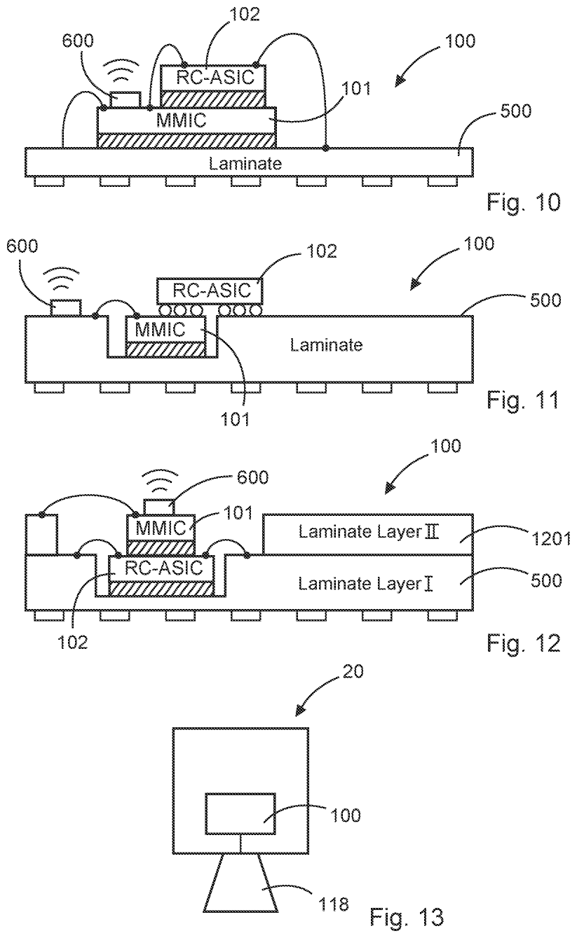

FIG. 10 shows an arrangement 100 with the primary radiator 600 on an intermediate level of the stacked ASICs 101, 102, namely on the upper side of the second ASIC (MMIC) 101. The first ASIC 102 is also arranged on the upper side of the second ASIC (MMIC) 101. The primary radiator is located next to it.

FIG. 11 shows an arrangement 100 with an MMIC or second ASIC 101 in a cavity of the carrier circuit board 500. The first ASIC 102 is located above the second ASIC (MMIC) 101, but shifted slightly to the side so that part of it rests on the substrate 500. The primary radiator 600 is also arranged on the upper side of the substrate 500.

FIG. 12 shows a further arrangement 100 in which both the first ASIC 102 and the second ASIC (MMIC) 101 are arranged in a deep cavity of a multilayer carrier circuit board 500. Here, the first ASIC 102 is located in a cavity of the lower laminate layer of the two-layer carrier circuit board and the second ASIC 101 is located above it. The lower ASIC 102 is connected to lines of the lower laminate layer by means of bonding wires and the upper ASIC 101 is connected to lines of the upper laminate layer by means of bonding wires.

FIG. 13 shows a measuring device 20 in the form of a radar level measuring device, which has the radar circuit described above and a level radar antenna 118 for emitting the radar measuring signal and for receiving the radar measuring signal reflected at the product surface.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A radar circuit for a level measuring device, comprising:
a first application-specific integrated circuit (ASIC); and
a second ASIC,
wherein the first ASIC has a first structure size and/or is manufactured by a first semiconductor technology,
wherein the second ASIC has a second structure size and/or is manufactured by a second semiconductor technology,
wherein the first structure size is different from the second structure size, and/or
wherein the first semiconductor technology is different from the second semiconductor technology.

2. The radar circuit according to claim 1, wherein the second ASIC has an operating range of one of 6 GHz, 24 GHz, 60 GHz, 80 GHz, 120 GHz, 180 GHz, or 240 GHz, or higher.

3. The radar circuit according to claim 1, wherein the second ASIC is a monolithic microwave integrated circuit (MMIC).

4. The radar circuit according to claim 1, wherein the first ASIC has an operating range in the megahertz range.

5. The radar circuit according to claim 1, wherein the first structure size is smaller than 50 nm.

6. The radar circuit according to claim 1, wherein the first ASIC and the second ASIC are arranged one above the other, stacked, or overlapping each other.

7. The radar circuit according to claim 1,
wherein the first ASIC is arranged on a carrier plate, and
wherein the second ASIC is arranged on the first ASIC.

8. The radar circuit according to claim 1,
further comprising a carrier plate,
wherein the second ASIC is arranged on or in a recess of the carrier plate, and
wherein the first ASIC is arranged on the second ASIC.

9. The radar circuit according to claim 1, wherein the first ASIC has a metallization on an upper side thereof as a reflector configured to reflect the radar measurement signals generated by the second ASIC.

10. The radar circuit according to claim 1,
further comprising a carrier plate,
wherein the carrier plate has a metallization as a reflector below the first ASIC configured to reflect the radar measurement signals generated by the second ASIC.

11. The radar circuit according to claim 1, further comprising:
a carrier plate; and
a primary radiator, arranged to emit the radar measurement signal generated by the second ASIC, which is arranged on the second ASIC or on the carrier plate.

12. The radar circuit according to claim 1, wherein the first ASIC comprises a phase locked loop (PLL), an analog-to-digital converter (ADC) circuit, a finite state machine (FSM), and/or a digital interface to a processor of the radar circuit.

13. The radar circuit according to claim 1, wherein the first ASIC is arranged to supply a voltage-controlled oscillator (VCO) of the second ASIC and/or a multiplier of the second ASIC.

14. The radar circuit according to claim 1, wherein the first ASIC and the second ASIC are separate components.

15. The radar circuit according to claim 1, wherein the radar circuit is configured to be used in a radar level meter.

16. A radar level meter comprising a radar circuit according to claim 1.
